(19) United States
(12) Patent Application Publication
(10) Pub. No.: US 2025/0083604 A1
(43) Pub. Date: Mar. 13, 2025

(54) LADDER FOR VEHICLES AND RELATED ASSEMBLY METHOD

(71) Applicant: TAKLER S.R.L., Altamura (Bari) (IT)

(72) Inventor: Lorenzo LORUSSO, Bari (IT)

(21) Appl. No.: 18/830,042

(22) Filed: Sep. 10, 2024

(30) Foreign Application Priority Data
Sep. 11, 2023 (IT) 102023000018621

(51) Int. Cl. B60R 3/00

(52) U.S. Cl. CPC B60R 3/007

(57) ABSTRACT

A ladder has a pair of uprights directed along a prevailing vertical direction and connected to each other by at least one cross member, perpendicular to the uprights, directed along a transverse direction, perpendicular to the vertical direction. The cross member acts as a step of the ladder. The uprights have coupling portions at the upper fixing ends, the coupling portions having two horizontal planes and a vertical joining rib, so as to have an overall “C” shape. The ladder has a pair of fixing counter-plates, each arranged on a side opposite to the coupling portion of the corresponding upright and removably fixed to the upper fixing end of the corresponding upright by removable connectors.

### CROSS-REFERENCE TO RELATED APPLICATION

This application claims priority to Italian Patent Application No. 102023000018621 filed Sep. 11, 2023, the contents of which is hereby incorporated in its entirety by reference.

### FIELD OF THE INVENTION

The present invention relates to an improved ladder for vehicles, typically for freight vehicles, such as trucks, lorries, semi-trailers, trailers and the like, and to a related assembly method of said ladder.

### PRIOR ART

As is known, vehicles are provided with a ladder, at the loading compartments or boxes, to make it easier for an operator to climb to the loading floor.

Such ladders are typically provided with one or more steps and are welded to the frame of the vehicle or of the loading platform thereof.

The fixed ladders of the prior art are subject to considerable wear and deterioration, even because they are fixed and thus exposed to the weather throughout the entire use of the vehicle.

Therefore, with prolonged use, it often happens that one or more steps can become damaged or detached. If this occurs, the ladder needs to be destructively disassembled, usually by unsoldering or cutting off the ladder walls connected/welded to the vehicle frame.

In the art, it was thus thought to provide removable ladder, which can be removed when they are not needed, so as to limit wear and extend the service life thereof.

However, it is necessary to provide ladders capable of being assembled and disassembled highly quickly because the vehicle driver must be able to access the loading compartment repeatedly during the use of the vehicle and must not waste time in the ladder assembly and storage operations.

Moreover, the need is felt to allow assembling the ladder to the vehicle frame without needing to drill holes in the spars and similar parts of the vehicle frame; indeed, drilling involves a number of technical disadvantages such as processing time and cost, the need for precision in drilling, as well as problems with rusting at the holes that, when drilled, inevitably result in the removal of paint from the spars.

In other words, the need is felt to provide a ladder with universal couplings which do not require any drilling on the frame of the vehicle and can be easily and quickly assembled and disassembled.

At the same time, removable ladder solutions must also ensure the necessary safety standards, despite the assembly and disassembly speed and simplicity.

The known solutions fail to ensure that the aforementioned requirements of ease of use, absence of drilling, and assembly and disassembly speed are met, while complying with adequate safety standards.

### SUMMARY OF THE INVENTION

Therefore, the need is felt to overcome the drawbacks and limitations mentioned with reference to the prior art.

Such a need is met by a ladder as described and claimed herein.

### DESCRIPTION OF THE DRAWINGS

Further features and advantages of the present invention will be more comprehensible from the following description of preferred, non-limiting embodiments thereof, in which:

FIG. 1 depicts a perspective view of a ladder according to a possible embodiment of the present invention;

FIG. 2 depicts a front view of the ladder in FIG. 1;

FIG. 3 depicts a side view of the ladder in FIG. 1;

FIG. 4 depicts a top plan view of the ladder in FIG. 1;

FIG. 5 depicts a perspective view of the ladder in FIG. 1, in a vehicle-mounted configuration;

FIG. 6 depicts a prospective view of a detail of FIG. 5;

FIG. 7 depicts a perspective view of the ladder in FIG. 5, in a vehicle-mounted configuration, from a different angle;

FIG. 8 depicts a front view of the ladder in FIG. 5, in a vehicle-mounted configuration; and

FIG. 9 depicts a perspective view and a front view of a fixing counter-plate of a ladder according to a possible embodiment of the present invention.

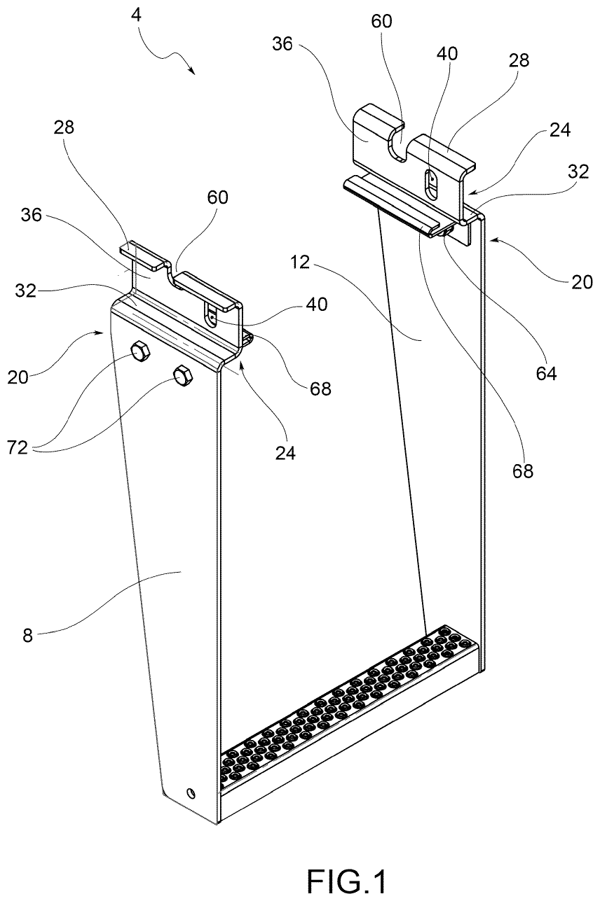

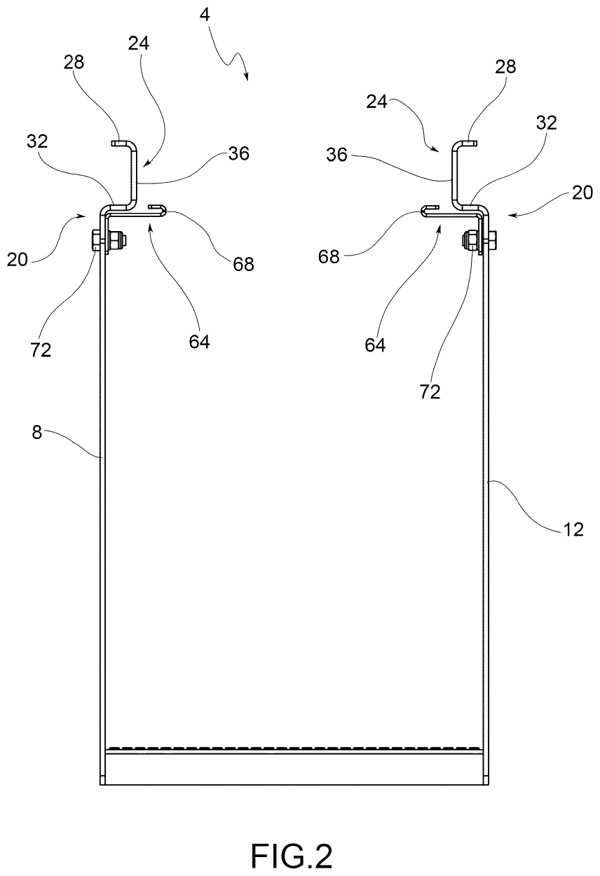

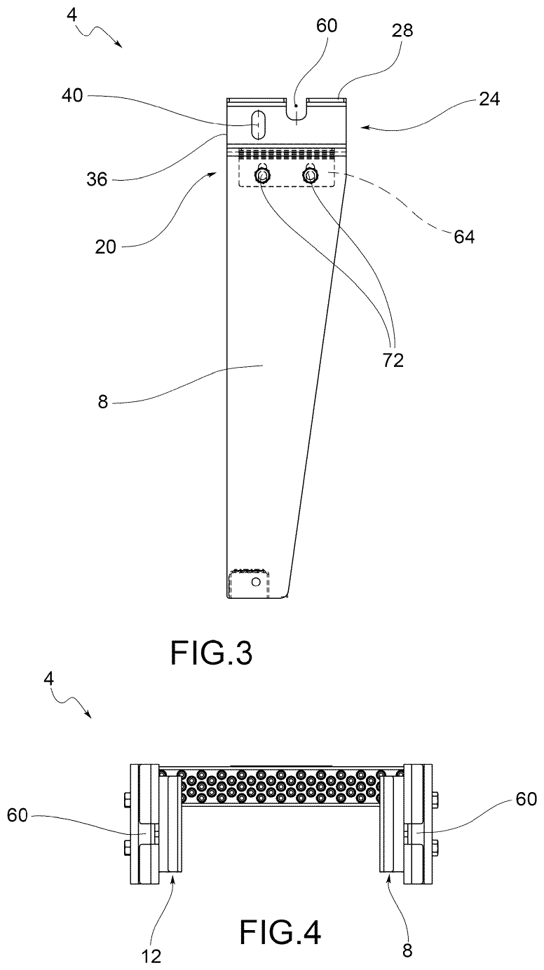

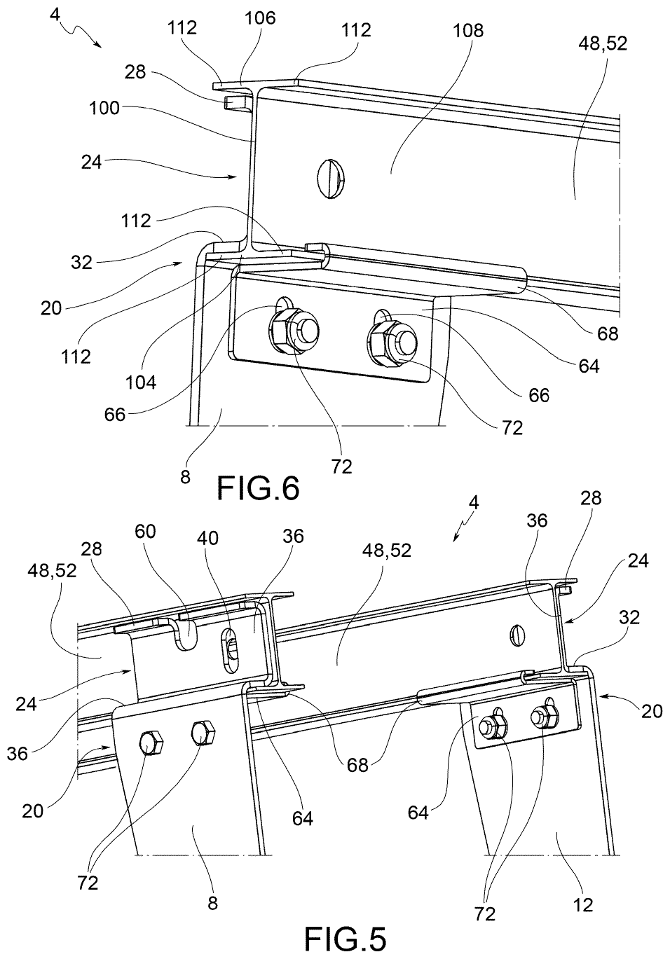

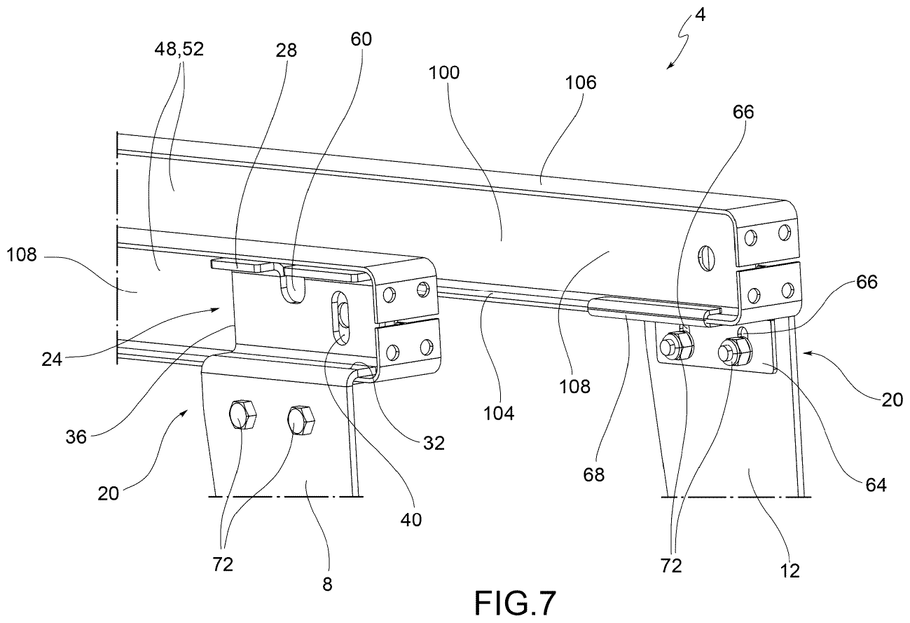

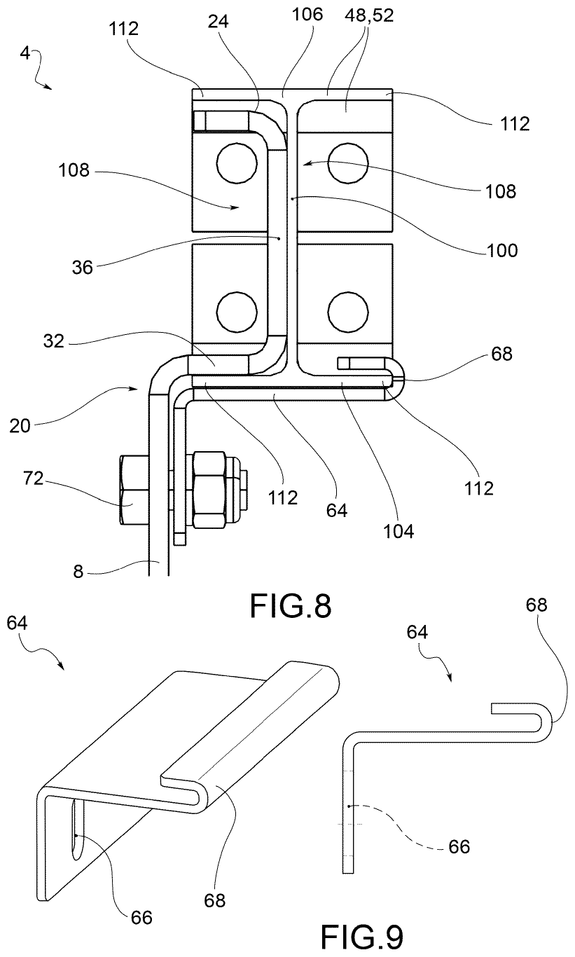

The elements or parts of elements common to the embodiments described below will be indicated by the same reference numerals.

### DETAILED DESCRIPTION

With reference to the figures, reference numeral 4 indicates a ladder as a whole.

Said ladder 4 comprises a pair of uprights 8,12, directed along a prevailing vertical direction Y-Y, where the uprights are connected to each other by at least one cross member 16, perpendicular to the uprights 8,12 themselves.

The cross member 16 is directed along a transverse direction X-X, perpendicular to said vertical direction Y-Y; the cross member 16 works as a step for the ladder 4.

Preferably, the ladder 4 comprises one or two cross members 16, i.e., one or two steps.

The uprights 8,12 comprise coupling portions 24 at the upper fixing ends 20.

Said coupling portions 24 comprise two horizontal planes 28,32 and a vertical joining rib 36, so as to have an overall ‘C’ shape.

According to a possible constructional variant, the coupling portions 24 can also be provided with at least one fixing hole 40 for inserting at least one fixing bolt of the ladder 4 to an associable frame 48 of a vehicle.

In particular, the coupling portions 24 are shaped so as to be coupled to a spar 52 of a floor of an associable vehicle.

According to a possible embodiment, said coupling portions 24 are at least partially flexible in a vertical direction Y-Y, so as to allow them to be coupled to a spar 52 of a floor of an associable vehicle.

The spars 52 can generally have a variety of sections, and the coupling portions 24 of the ladder are counter-shaped with respect to said sections. Preferably, the spars have IPE sections, i.e., ‘I’ or double ‘T’ sections; it is also possible, as an alternative, to provide spars having different sections, such as ‘I’ section or rectangular section; in the latter case, the coupling portions 24 are counter-shaped with respect to the base and height of said rectangular section.

More in detail, the spar 52 comprises a vertical segment 100 and a lower transverse base 104, perpendicular to the vertical segment 100, and an upper transverse base 106, parallel to the lower transverse base 104 and connected to the latter by the vertical segment 100. Such a shape identifies a pair of concave seats 108 on opposite sides of the vertical segment 100; at least one of said concave seats 108 of the spar 52 houses said coupling portion 24.

Preferably, the coupling portions 24 are arranged symmetrically with respect to a centreline plane M-M of the ladder, perpendicular to said transverse direction X-X.

According to a possible embodiment, the coupling portions 24 are arranged so as to have the respective vertical joining ribs 36 in an external position, on the opposite side of the centreline plane M-M, with respect to the corresponding uprights 8,12. Such a shape adapts to frames 48 in which the respective spars 52 are arranged at a mutually widen pitch, or even at a greater pitch than the transverse width of the cross member 16 of the ladder 4.

According to a possible embodiment, the coupling portions 24 are arranged so as to have the respective vertical joining ribs 36 in an internal position, on the same side of the centreline plane M-M, with respect to the corresponding uprights 8,12. Such a shape adapts to frames 48 in which the respective spars 52 are arranged at a mutually narrow pitch, or even at a smaller pitch than the transverse width of the cross member 16 of the ladder 4.

According to a possible embodiment, at least one of said horizontal planes 28,32 is provided with a recess 60. Said recess 60 is preferably shaped so as to avoid interference with protruding portions of the frame 48 and/or of the spars 52.

According to a possible embodiment, said uprights 8,12 are at least partially elastically flexible, in the transverse direction X-X, so as to allow elastic spreading or squeezing of the coupling portions 24 along said transverse direction X-X.

Advantageously, the ladder 4 comprises a pair of fixing counter-plates 64, each being arranged on the side opposite to the coupling portion 24 of the corresponding upright 12,16.

Each fixing counter-plate 64 is removably fixed to the upper fixing end 20 of the corresponding upright 12,16, by removable connection means 72. For example, the removable connection means 72 comprise screws, pins or bolts which are inserted into appropriate adjustment holes 66 obtained on the fixing counter-plate 64 and aligned with corresponding through holes obtained on the upper fixing end 20 of the uprights 8,12. Preferably, said adjustment holes 66 are slotted.

In particular, each fixing counter-plate 64 comprises a folded portion 68, configured to be coupled to the spar 52, in particular to a cantilevered end 112 of the lower 104 and/or upper 106 transverse base of the spar 52, on the side opposite to the corresponding coupling portion 24.

In other words, the coupling portion 24 and the fixing counter-plate 64 are locked on the upright on opposite sides along the transverse direction X-X so as to create a bilateral axial constraint (or transverse undercut) with the spar 52, with respect to said transverse direction X-X.

The folded portion 68 extends parallel to the horizontal planes 28,32 of the coupling portions 24.

With respect to the vertical direction Y-Y, the locking of the uprights 8,12 with respect to the spar 52 is ensured, on the one hand, by the shape coupling between the coupling portion 24 and the concave seat 108 of the spar 52 itself, and on the other hand, by the coupling between the folded portion 68 and the cantilevered end 112 of the lower 104 and/or upper 106 transverse base of the spar 52.

The ladder 4 can be made of any material; preferably, it is made of a metal material. According to a possible embodiment, the ladder 4 is made of hot-dip galvanized carbon steel.

The assembly/disassembly operation of a ladder according to the present invention will now be described.

In particular, the assembly includes juxtaposing said ladder 4 to the spars 52 of the floor or frame 48 of the vehicle, so as to couple each of said coupling portions 24 to a corresponding spar 52.

This step includes elastically spreading or juxtaposing the coupling portions 24 to the spars 52 so as to allow fixing the ladder 4 to the spars 52 by shape coupling between the coupling portions 24 and the spars 52 themselves.

The juxtaposition and elastic deformation of the uprights 8,12 and/or coupling portions allows adapting the ladder 4 to frames 48 and/or spars 52 of different sizes or however taking into account the possible tolerances of the structures to which the ladder 4 is to be coupled.

In this step, the fixing counter-plates 64 are not fixed to the upper fixing ends 20 of the uprights 8,12. Once the position of the ladder 4 with respect to the spar 52 has been pre-set, the folded portions 68 are coupled to the respective cantilevered ends 112 of the lower 104 and/or upper 106 transverse base of the spar 52 and the fixing counter-plates 64 are locked to the upper fixing ends of the uprights 8,12 by the removable connection means 72.

As can be appreciated from the above description, the solutions described allow overcoming the drawbacks introduced in the prior art.

In particular, the ladder according to the present invention can be assembled and disassembled very conveniently and quickly by a single operator, without using specific tools.

The assembly/disassembly operation can be repeated several times during the use of the vehicle, even on the same day, without resulting in significant slowdowns of the work activity of loading/unloading goods.

The assembly operation does not include any drilling or machining on the vehicle frame, which therefore remains intact and never compromised.

The ladder is safe and complies with the necessary safety standards while being removable.

For example, if a step on the ladder breaks, the operator can easily replace the ladder by easily removing it from the frame of the vehicle, without using specific tools and without having to destroy/remove welded parts.

In order to meet contingent, specific needs, those skilled in the art may make several changes and variations to the solutions described above.

The scope of protection of the invention is defined by the following claims.

1. A ladder comprising:
a pair of uprights, directed along a prevailing vertical direction;
said uprights being connected to each other by at least one cross member, perpendicular to the uprights, directed along a transverse direction, perpendicular to said vertical direction, said cross member acting as a step of the ladder;
wherein the uprights comprise coupling portions at upper fixing ends,
said coupling portions having two horizontal planes and a vertical joining rib, to overall have a “C” shape; and
wherein the ladder further comprises a pair of fixing counter-plates, each fixing counter-plate being arranged on a side opposite to the coupling portion of the corresponding upright; and
each fixing counter-plate being removably fixed to the upper fixing end of the corresponding upright, by one or more removable connectors.

2. The ladder of claim 1, wherein each fixing counter-plate comprises a folded portion configured to couple to a spar of a vehicle.

3. The ladder of claim 2, wherein the coupling portion and the fixing counter-plate are locked on each upright on opposite sides along the transverse direction to create a bilateral axial constraint with the spar, with respect to said transverse direction.

4. The ladder of claim 2, wherein the folded portion extends parallel to the horizontal planes of the coupling portions.

5. The ladder of claim 1, wherein the one or more removable connectors comprise screws, pins or bolts which are inserted into adjustment holes on the fixing counter-plate and aligned with corresponding through holes on the upper fixing end of the uprights.

6. The ladder of claim 5, wherein said adjustment holes are slotted.

7. The ladder of claim 1, wherein said coupling portions are shaped to engage with a spar of a floor of an associable vehicle.

8. The ladder of claim 1, wherein said coupling portions are at least partially elastically flexible in the vertical direction, to allow coupling to a spar of a floor of an associable vehicle.

9. The ladder of claim 1, wherein said coupling portions are arranged symmetrically with respect to a centerline plane of the ladder, perpendicular to said transverse direction.

10. The ladder of claim 9, wherein said coupling portions are arranged to have respective vertical joining ribs in an external position, on an opposite side of the centerline plane, with respect to the corresponding uprights.

11. The ladder of claim 9, wherein said coupling portions are arranged to have respective vertical joining ribs in an internal position, on a same side of the centerline plane, with respect to the corresponding uprights.

12. The ladder of claim 1, wherein a fixing hole is arranged on the vertical joining rib.

13. The ladder of claim 1, wherein at least one of said horizontal planes comprises a recess.

14. The ladder of claim 1, wherein said uprights are at least partially elastically flexible, in the transverse direction, to allow elastic spreading or squeezing of the coupling portions along said transverse direction.

15. The ladder of claim 1, wherein said ladder comprises hot galvanized carbon steel.

16. A method of assembling a ladder, comprising:
providing a ladder comprising:
a pair of uprights, directed along a prevailing vertical direction,
said uprights being connected to each other by at least one cross member, perpendicular to the uprights, directed along a transverse direction, perpendicular to said vertical direction, said cross member acting as a step of the ladder,
wherein the uprights comprise coupling portions at upper fixing ends,
said coupling portions having two horizontal planes and a vertical joining rib, to overall have a C shape, and
wherein the ladder further comprises a pair of fixing counter-plates, each fixing counter-plate being arranged on a side opposite to the coupling portion of the corresponding upright, and
each fixing counter-plate being removably fixed to the upper fixing end of the corresponding upright, by one or more removable connectors;
providing a vehicle having a floor and a plurality of spars parallel to each other;
juxtaposing said ladder to the spars, so as to engage each of said coupling portions to a corresponding spar;
coupling folded portions of the fixing counter-plates to respective cantilevered ends of a lower and/or upper transverse base of the spar; and
locking the fixing counter-plates to the upper fixing ends of the uprights by the one or more removable connectors.

17. The ladder of claim 1, wherein each fixing counter-plate comprises a folded portion configured to couple to a cantilevered end of a lower and/or upper transverse base of a spar of a vehicle, on the opposite side with respect to the corresponding coupling portion.

18. The ladder of claim 17, wherein the coupling portion and the fixing counter-plate are locked on each upright on opposite sides along the transverse direction to create a bilateral axial constraint with the spar, with respect to said transverse direction.

19. The ladder of claim 17, wherein the folded portion extends parallel to the horizontal planes of the coupling portions.
